(19) United States
(12) Patent Application Publication
(10) Pub. No.: US 2025/0230095 A1
(43) Pub. Date: Jul. 17, 2025

(54) Agglomerates of Carbon Nanotube Hybrid Materials

(71) Applicant: Chasm Advanced Materials, Inc., Canton, MA (US)

(72) Inventors: Ricardo A. Prada Silvy, Norman, OK (US); Hari K. Harikumar, East Walpole, MA (US); David J. Arthur, Braintree, MA (US); Robert F. Praino, JR., Westwood, MA (US); Ying Li, Wellesley, MA (US)

(73) Assignee: Chasm Advanced Materials, Inc., Canton, MA (US)

(21) Appl. No.: 19/170,321

(22) Filed: Apr. 4, 2025

Related U.S. Application Data
(63) Continuation of application No. PCT/US2024/049147, filed on Sep. 28, 2024.
(60) Provisional application No. 63/541,412, filed on Sep. 29, 2023.
(60) Provisional application No. 63/544,061, filed on Oct. 13, 2023.
(60) Provisional application No. 63/546,436, filed on Oct. 30, 2023.

(51) Int. Cl. C04B 18/02

(52) U.S. Cl. CPC C04B 18/021

(57) ABSTRACT

An agglomeration with fine particles of a hybrid material comprising carbon nanotubes (CNT) and a binder agent that is effective to create an agglomeration comprising the fine particles.

### CROSS-REFERENCE TO RELATED APPLICATIONS

This application is a continuation of and claims priority of PCT application PCT/US2024/049147 filed on Sep. 28, 2024, the entire disclosure of which being incorporated by reference herein for all purposes. PCT/US2024/049147 claims priority of the following Provisional Patent Applications, the disclosures of which are each incorporated by reference herein, and for all purposes: 63/541,412 filed on Sep. 29, 2023; 63/544,061 filed on Oct. 13, 2023; and 63/546,436 filed on Oct. 30, 2023.

### BACKGROUND OF THE INVENTION

The concrete industry, like the energy sector, is facing significant technological challenges driven by environmental pressures. These pressures require a substantial reduction in CO₂ emissions during cement production and economic incentives to improve construction materials performance, making structural components stronger, thinner, and lighter at lower costs. These demands, encompassing technical, environmental, and economic factors, will significantly impact production costs and, consequently, market prices.

In 2022, global cement production reached approximately 4.1 billion tons, constituting about 8.0% of the world's total CO₂ emissions, which amounted to roughly 36.8 billion metric tons of emissions. China, India, and the United States contributed 2.17 billion MT, 370 million MT, and 95 million MT, respectively. In order to align with the Net Zero Emissions by 2050 (NZE) Scenario, the concrete sector must achieve a 4% reduction in CO₂ intensity by the year 2030. Given accelerated economic and population growth, particularly in regions like Asia and the Middle East, it is projected that global cement production capacity will increase to about 5 billion metric tons by 2030. Currently, China leads worldwide cement production at approximately 52%, followed by India at approximately 10%.

During the cement manufacturing process, carbon dioxide is released when producing clinker, a key component of cement. In this process, calcium carbonate (CaCO₃) is heated in a rotary kiln furnace, leading to a series of complex chemical reactions. CO₂ is released as a by-product during calcination, which takes place in the upper, cooler end of the kiln or in a pre-calciner. This occurs at temperatures ranging between 60° and 900° C., resulting in the conversion of carbonates into oxides.

CaCO₃+Heat→CaO(lime)+CO₂

At higher calcination temperatures in the lower end of the kiln, the lime, the primary component of cement, reacts with materials containing silica, aluminum, and iron to produce minerals in the clinker (such as 2CaO—SiO₂, 3CaO—SiO₂, 3CaO—Al₂O₃, 4CaO—Al₂O₃—Fe₂O₃). The clinker, a multiphase calcium-silica compound, typically exhibits grain sizes ranging from micrometers to a few millimeters and serves as an intermediate product in cement manufacturing. After extraction from the kiln for cooling, it is ground into a fine powder and then combined with approximately 5 wt % of gypsum. This mixture results in the most common type of cement known as Portland cement. Masonry cement is generally the second most common type of cement. However, since Masonry cement requires more lime than Portland cement, its production generally leads to additional CO₂ emissions. An estimated factor of about 0.507 MT of CO₂ emissions per MT of clinker for Masonry type cement has been reported.

Calcium silicates, specifically 2CaO—SiO₂ (C₂S, alite) and 3CaO—SiO₂ (C₃S, belite), are responsible for cement's mechanical properties. In contrast, 3CaO—Al₂O₃ (C₃A, tricalcium aluminate) and 4CaO—Al₂O₃—Fe₂O₃ (C₄AF, brown millerite) promote the formation of the liquid phase during firing in the production of Portland cement. Various types of Portland cement exist, differing in their calcium and alumina silicate compositions. Type I is suitable for general use, Type II generates relatively low heat during hydration (an exothermic reaction), and Type III offers relatively high early strength.

Calcium silicate compounds have specific rates of reaction with water, producing various hydration products that intermesh and intercalate to create a dense and strong solid during the hydration process.

C₃S+H₂O→C—S—H*+Ca(OH)₂

C₂S+H₂O→C—S—H*+Ca(OH)₂

C₃A+18H₂O→C₂AH₈+C₄AH₁₀

2C₃A+32H₂O+3 Ca²⁺+SO₄²⁻→C₆AS₃H₃₂

C₆AS₃H₃₂+2C₃A→3C₄ASH₁₂

C₄AF has an analogous reaction to C₃A and produces C₆(A,F)S₃H₃₂.

C—S—H* is an amorphous hydrogel with a variable composition in terms of Ca/Si ratio and H₂O/SiO₂ ratios.

The reaction of C₃A with water is exothermic and generates significant heat quickly, mainly contributing to early strength rather than ultimate strength. Longer-term strength primarily depends on calcium silicates, with C₃S providing early strength and C₂S offering better long-term contributions. The principal binding phase in Portland cements is the C—S—H*, which is the most significant hydration product in qualitative terms. Ferrite reactions fall between C₃S and C₂S in terms of rate but play a crucial role in long-term strength and durability.

Admixtures are solid or liquid ingredients added to a cement mix alongside cement, water, and aggregates. They aim to enhance the fluidity of the mix or improve certain properties of the resulting cured cement. Water-reducing agents are commonly used to enhance fluidity. Insufficient fluidity leads to relatively high porosity in cured cement due to incomplete water utilization in the hydration reaction. Silica fume, an admixture consisting of fine non-crystalline silica particles (finer than sand, as small as 0.1-0.2 μm), can refine the pore structure of cured cement, thus enhancing strength and modulus.

Numerous strategies have been employed to enhance concrete sustainability and develop green alternatives. These strategies include:
i) Reducing the clinker-to-cement ratio by adopting clinker substitutes.
ii) Incorporating recycled materials and waste from various sources such as industry, agriculture, and households.
iii) Optimizing mix designs.
iv) Reducing CO₂ emissions by decreasing Portland cement content and partially substituting it with cementitious materials and binders like nano-alumina particles, fly ashes, silica fume, limestone, and blast furnace slag.
v) Enhancing concrete durability by using reinforcing materials such as carbon fibers (CFs), carbon nanotubes (CNTs), and steel fibers, thereby reducing long-term resource consumption and adopting low-impact construction methods.
vi) Continuously improving energy efficiency.
vii) Embracing low-carbon fuels.
viii) Implementing innovative technologies like Carbon Capture and Storage (CCS), which will play a pivotal role in achieving the emissions reduction goal.

Among the additives employed to enhance the mechanical properties of cementitious materials, nano-Al₂O₃ particles have proven to be effective in increasing the modulus of elasticity in cement mortar. With approximately 5 wt. % of nano-Al₂O₃ particles, each having a size of hundreds of nanometers, the elastic modulus increased by 143% after 28 days of curing. During cement hydration, these particles filled the pores at the sand-paste interfaces, creating a denser interfacial transition zone (ITZ) with reduced porosity. This densification of the ITZ is responsible for the significant increase in the elastic modulus of the mortars.

The incorporation of carbon nanomaterials into the cementitious matrix offers a promising approach to achieving the performance objectives of concrete. Carbon nanotubes (CNTs) have gained significant attention due to their remarkable mechanical properties (Young's modulus of 1TPa, tensile strength exceeding 60 GPa, and fracture deformation exceeding 12%), low density, unique physical and chemical characteristics, thermal and electrical conductivity, as well as piezoelectric properties. CNTs even exhibit a thermal conductivity at least twice that of diamond, and their negative coefficient of thermal expansion contributes to higher thermal stability. These properties make them valuable for enhancing the thermal stability of cement-based materials, positioning CNTs as ideal candidates for reinforcement in smart cement-based materials.

However, effectively dispersing carbon nanotubes in construction materials presents a significant technological challenge due to their high hydrophobic nature, which causes CNTs to tend to form bundles or ropes in aqueous and organic suspensions. This characteristic impedes their efficient integration into the cementitious matrix. Cement particles typically range in size from 1 to 3 μm, exhibiting a wide size distribution. Some studies have successfully combined chemical and mechanical dispersion techniques for CNTs, utilizing surfactants and ultrasonication to aid dispersion, as well as water-reducing additives to adjust the fluidity of CNT-cement mixtures. It has been reported that achieving an optimal CNT aspect ratio is necessary to enhance the electromechanical properties with minimal CNT loading in the concrete matrix. Unfortunately, ultrasonication and high shear mixing techniques are not scalable for commercial purposes and can potentially damage the CNTs, thereby reducing their effectiveness in enhancing mechanical strength, electrical and thermal conductivity, and piezoelectric response.

Handling CNT powders represents potential health and safety risks, and their high production cost makes them impractical for cost-sensitive construction materials markets. Therefore, the development of new-generation hybrid materials containing CNTs and techniques for integrating them into cement matrices using conventional mixing equipment becomes necessary. This approach aims to avoid the use of aqueous solutions containing surfactants and water-reducing agents. These new techniques for incorporating carbon nanotubes into cement must be efficient enough to ensure a significant improvement in mechanical properties, while also being safe and cost-effective to produce.

### SUMMARY OF THE INVENTION

This invention introduces novel compositions and novel methods for safely integrating CNT-nano-Al₂O₃ hybrid materials into the cement matrix using conventional industrial mixing techniques. The CNT-nano-Al₂O₃ hybrid material is preferably synthesized through the Catalytic Chemical Vapor Deposition (CCVD) method. The CNT synthesis takes place in a fluidized bed or rotary tube reactor, utilizing active metal supported on alumina grains having primary particles sized in the hundreds of nanometers. During the CNTs synthesis conditions, the primary particles contained in the catalyst support grains tend to de-agglomerate and disperse into an open and expanded mesh formed by carbon nanotubes. When carbon nanotubes form an open and expanded mesh, less energy is required to de-bundle and disperse them.

The CNT-nano-Al₂O₃ hybrid material obtained in the synthesis is then ground using various types of mills, such as; planetary ball mill, attrition mill, roller mill, vibrator mill, jet mill, pin mill, disc mill among others to reduce the size of the expanded mesh of carbon nanotubes and optimize its aspect ratio to achieve better integration of the material into the cementitious matrix. The resulting fine powder, with particle sizes in the micron range, can then be shaped through granulation methods in the presence of a binder agent (such as colloidal silica, alumina, and/or polymers) and blended with admixture materials (such as fume silica, fly ash, limestone, hydrogels, etc.) before being mechanically mixed with the cementitious material.

Also featured in this disclosure is an encapsulated carbon nanotube (CNT)-containing hybrid material structure that in some examples includes a core and a shell surrounding some or all of the core and comprising a polymer or a macromolecule. The concentration of the hybrid material is greater in the core than it is in the shell.

In some examples the hybrid material comprises CNT and a cementitious material. In some examples the cementitious material comprises alumina. In some examples the polymer comprises alkali lignin. In some examples the macromolecule comprises at least one of a superplasticizer, a defoaming agent, and/or a binder. In some examples the encapsulated CNT-containing hybrid material structure is made by spray drying a liquid dispersion of a CNT-containing hybrid material and a dispersant. In some examples this disclosure features a mortar comprising the encapsulated CNT-containing hybrid material structure described above, water, cement, and sand.

Also featured herein is a CNT-containing cementitious material that in some examples includes a CNT hybrid material comprising a cementitious material, a dispersant, and a defoamer. The components are mixed in a continuous high shear mixing equipment to develop the CNT-containing cementitious material.

In some examples the cementitious material comprises alumina. In some examples the dispersant comprises alkali lignin. In some examples the defoamer comprises an air-detraining admixture. In some examples this disclosure features a mortar comprising the CNT-containing cementitious material described above, water, cement, and sand.

In some examples the cementitious material comprises alumina. In some examples this disclosure features a mortar comprising the CNT-containing cementitious material described above, water, and sand.

Examples of the present disclosure include an additive product in which CNTs are well-dispersed in water or organic solvent using industrial methods. The dispersion can be accomplished with a dispersant polymer (and/or oligomers, macromolecules) including lignin, polyvinylpyrrolidone (PVP), polyvinyl alcohol (PVA), carboxymethyl cellulose (CMC), etc. The dispersant can contain at least one functional group that exhibits strong interactions at the CNT surface, e.g. adsorbing onto the CNT surface, promoting a stable and well-dispersed suspension, and, at the same time, compatible with water or organic solvent surrounding the CNTs. In some examples the dispersion is accomplished by methods that do not involve batch sonication. An exemplary dispersion method is the use of continuous bead milling.

In examples, the dispersion is dried to remove water or organic solvent using industrial methods such as scalable spray drying, freeze drying, etc. Alternatively, the additive product can be created by direct dry-processing of solid-state solutions without the need to make liquid dispersion first.

In some examples the end product is dried granules with a 3D structure, unlike prior art 2D flakes of an alkali lignin dispersion that is cast as a film and then broken up into 2D pieces or flakes. Compared to 2D flakes, 3D granules are more readily integrated into industrial applications. For example, 3D granules can have core-shell morphology with well-dispersed CNT-rich core and dispersant-rich shell for re-dispersion in cementitious material. Or 3D granules can have non-core-shell morphology, e.g. a permeable shell to facilitate dispersion of CNT. In some examples the dispersion is such as to reach the percolation threshold.

In some examples the composition of the granules is defined by a dispersant to CNT ratio or the non-dispersant to CNT ratio. In examples the dispersant to CNT ratio is designed to achieve the target mechanical or electrical performance while maintaining good dispersion and re-dispersibility. Non-limiting examples of dispersants include lignin, PVP, PVA, PEG, amine, and the like. Examples of non-dispersants include superplasticizers, defoaming agents, binders, etc.

The end product can be introduced into applications (e.g., cement or concrete) wet or dry. In some examples the dried granules are re-dispersed to form well-dispersed liquid first. Or the dried granules can be directly integrated into applications as granules, such as by industrial mixing methods.

Applications of the granules include cement/mortar/concrete, and energy storage (e.g., anodes and/or cathodes of storage batteries such as lithium-ion batteries.

In one aspect an agglomeration includes fine particles of a hybrid material comprising carbon nanotubes (CNT), and a binder agent that is effective to create an agglomeration comprising the fine particles.

In some examples the agglomeration further includes cementitious material. In an example the cementitious material comprises alumina particles. In an example the cementitious material comprises nano-alumina particles. In an example the agglomeration includes an admixture of one or more other cementitious materials. In an example the one or more other cementitious materials includes one or more of fume silica, fly ash, limestone, and a hydrogel. In an example the cementitious material includes one or more of fume silica, fly ash, or limestone. In an example the binder agent includes one or more of colloidal silica or colloidal alumina.

In some examples the binder agent includes colloidal material. In an example the colloidal material includes one or more of colloidal silica or colloidal alumina. In an example the binder agent includes a superplasticizer.

In another aspect a method of dispersing carbon nanotubes (CNT) in cementitious material includes creating the agglomeration as described herein and blending the agglomeration with one or more components of cement, to develop an intermediate product. In an example the method includes creating concrete using the intermediate product. Another aspect includes concrete created by these methods.

In another aspect an encapsulated carbon nanotube (CNT)-containing hybrid material structure includes a core and a shell surrounding some or all of the core. The shell includes a polymer or a macromolecule. The concentration of the hybrid material is greater in the core than it is in the shell.

In some examples the hybrid material includes CNT and a cementitious material. In an example the cementitious material includes alumina. In an example the polymer includes alkali lignin. In an example the macromolecule includes at least one of a superplasticizer, a defoaming agent, and a binder. In an example the encapsulated CNT-containing hybrid material structure is made by spray drying a liquid dispersion of a CNT-containing hybrid material and a dispersant. Also included is a mortar including the encapsulated CNT-containing hybrid material structure, water, cement, and sand. Also included is a concrete including the encapsulated CNT-containing hybrid material structure, water, cement, sand, and gravel.

### BRIEF DESCRIPTION OF DRAWINGS

FIG. 1 is a schematic representation of a production process of CNT-nano-Al₂O₃ hybrid material and its integration into cement.

FIG. 2 illustrates several different options for CNT-nano Al₂O₃ granulation and encapsulation.

FIG. 3 includes scanning electron microscope (SEM) images of granules of CNT-nano-Al₂O₃ hybrid material.

FIG. 4 includes SEM images of granules of CNT-nano-Al₂O₃ hybrid material-colloidal silica.

FIG. 5 includes SEM images of granules of CNT-nano-Al₂O₃ hybrid material, fume silica and colloidal silica.

FIG. 6 includes SEM images of granules of CNT-nano-Al₂O₃ hybrid material encapsulated with colloidal silica.

FIG. 7 includes SEM images of granules of CNT-nano-Al₂O₃ hybrid material, fly ash and colloidal silica.

FIG. 8 includes SEM images of granules of CNT-nano-Al₂O₃ hybrid material produced with super plasticizer agent.

FIG. 9 includes micrographs illustrating the morphologies of the granules of CNT hybrid material.

FIG. 10A is a plot of UV/Vis spectra of a CNT hybrid material dispersion before drying and FIG. 10B shows it re-dispersed from dried flake.

FIG. 11A is an optical micrograph of a CNT hybrid material dispersion before drying and FIG. 11B shows it after re-dispersion.

FIG. 12 includes SEMs of micro-encapsulated CNT-alumina hybrid material flakes.

### DETAILED DESCRIPTION OF THE INVENTION

This disclosure includes hybrid materials based on CNT (Carbon Nanotubes) and cementitious material such as alumina nanoparticles. In some examples the hybrid material can be used in advanced construction materials. This innovative material significantly enhances the electro-mechanical properties, along with reduced cement usage, in concrete, thereby helping to reduce CO₂ emissions. Also disclosed are materials and methods for easily and safely integrating the CNT-nano-Al₂O₃ hybrid material into the cementitious matrix using conventional mixing equipment.

In some examples the hybrid material is synthesized using a catalyst based on a combination of transition metal oxides (Co, Fe, Mo) supported on high specific surface area MgO—Al₂O₃ (e.g., specific surface area in the range of 200-400 m²/g). A catalyst preparation method was described in US Patent Application publication 2023/0116160 A1, the disclosure of which is incorporated herein by reference and for all purposes.

The CNT-nano-Al₂O₃ hybrid material can be synthesized in a rotary tube reactor or fluidized bed reactor using a carbon source (such as C₂-C₄ alkanes or alkenes) and hydrogen at a temperature between 60° and 750° C., atmospheric pressure, and a residence time in the reactor between 5 and 20 minutes. CNT-alumina hybrid material synthesis is further described in US Patent Application publication 2023/0116160 A1.

The carbon nanotube content in the hybrid material ranges from 15 to 85 wt %, preferably between 20 and 75 wt %. The content of MgO—Al₂O₃ support in the catalyst varies between 96.6 and 98.5 wt %, and the active metal (e.g., Co and Fe) content ranges from 1.45 to 2.9 wt %. The catalyst contains micron-sized elementary nano-alumina particles which are agglomerated to form catalyst grains that have a particle size of less than 500 μm, preferably less than 150 μm when a rotary tube reactor is used and between 150-500 μm when a fluidized bed reactor is used. The active metal is deposited on the catalyst grains. The elementary nano-alumina particles typically have sizes ranging from 600 to 1500 nm. During the initial stage of the catalytic reaction, the growth of CNTs causes de-agglomeration of the elementary particles that form the catalyst grains. As the reaction progresses, these elementary particles are dispersed in a three-dimensional open mesh of carbon nanotubes. The morphological properties of the support (shape and size of the particles) as well as the composition of the active phase in the catalyst determine the structure and morphology of the three-dimensional mesh of carbon nanotubes. The more open and less tangled the carbon nanotube mesh is, the easier it is to disperse with less energy usage in mixing equipment.

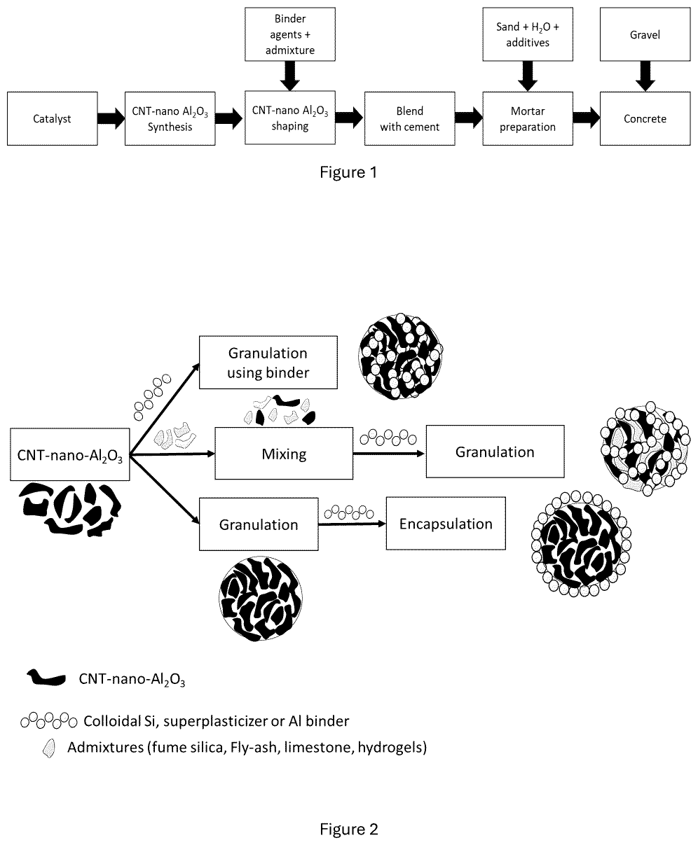

FIG. 1 schematically illustrates a non-limiting example of the production process of the CNT-nano-Al₂O₃ hybrid material, the creation of granules that contain the hybrid material, and the integration of the hybrid material into cement and concrete. After the synthesis of the hybrid material, the powdered hybrid material undergoes a grinding process to untangle and adjust the aspect ratio and size of the CNT-mesh in order to increase the surface area and quality of contact with cement particles. Reducing the size of the CNT mesh facilitates the shaping process and its subsequent integration into the cement matrix. A ball mill, planetary mill, or a conventional mechanical grinder apparatus as above described can be used for reducing and tailoring CNT-nano-Al₂O₃-mesh size. After grinding the hybrid material to sizes below 50 μm, preferably below 20 μm, the fine, low-density powder is blended with a solution containing binder agents and admixtures to obtain granules a few millimeters in diameter. Subsequently, granules of CNT-admixture ranging in size from 1 to 5 mm are mechanically blended with cement, sand, and additives, such as a superplasticizer, to prepare mortar. This mortar is combined with gravel to produce concrete.

The granulation of fine particles offers numerous advantages, including:
i) Improving the rheological properties of materials.
ii) Preventing the segregation of components in the powdery mixture during processing.
iii) Facilitating the handling of powders with toxic components, reducing the risk of exposure.
iv) Reducing the tendency to clump when the product is piled up.
v) Facilitating uniform filling of containers.
vi) Increasing the amount of material added per volume of the container.

The granulation of hybrid material can be carried out using various devices, such as a spray dryer to obtain microspheres, a high-shear mixer, a rotary granulator, or by employing drop coagulation techniques, etc.

FIG. 2 schematically illustrates three different non-limiting options for granulating the hybrid CNT-nano-Al₂O₃ hybrid material. The first option involves granulating the powder in the presence of a binder agent (such as silica or colloidal alumina, copolymers, etc.). In this case, granules are obtained where the CNT mesh is compacted and bound together through the binder particles. The CNT-Nano-Al₂O₃/binder solution ratio should be adjusted to ensure the granules have appropriate mechanical strength, preventing the formation of fine CNT dust during material handling due to abrasion or attrition of the particles. Similarly, it is helpful to formulate the granules to ensure easy disaggregation and proper dispersion of the hybrid material when the granules come into contact with water and cement during mortar preparation.

A second option involves mixing powders of the hybrid material with admixtures (such as fume silica, fly ash, limestone, hydrogels, etc.), followed by granulation in the presence of a binder. In this case, the admixture particles keep the CNT-nano-Al₂O₃ meshes separated and dispersed, allowing for better integration into the cement matrix. When mixing admixture particles with the hybrid material, it is useful to adjust the composition of the mixture to ensure the formation of granules with good mechanical properties.

A third option is to granulate the CNT-nano-Al₂O₃ powder with water followed by encapsulation in the presence of a colloidal Si or Al binder. This option would inhibit or prevent the detachment of CNT-nano-Al₂O₃ from the granulated material.

At least two non-limiting methods of integrating the granulated/encapsulated material into the cementitious matrix are described here:
I) Directly adding the CNT-nano-Al₂O₃ granules to the cement during the production of mortar.
II) Mixing the granules with admixtures, such as fly ash, limestone, fume silica, and then adding the mixture to the cement, followed by mixing it with sand to produce mortar and ultimately concrete.

Non-limiting examples of aspects of the disclosure are set forth below:

### Example 1: Granulation of CNT-Nano-Al₂O₃ Hybrid Material

In this example, 2.5-3.5 mm granules of ground CNT-nano-Al₂O₃ hybrid material were produced by adding deionized (DI) water to ensure proper moisture content (approximately 1.0-1.5 parts water per 1.0-part CNT powder by weight). These granules were created using a high shear mixer operating at 1500 rpm for approximately 1.30 to 2.0 minutes and then air-dried at room temperature for 2 hrs. and then at 60° C. for 30 minutes.

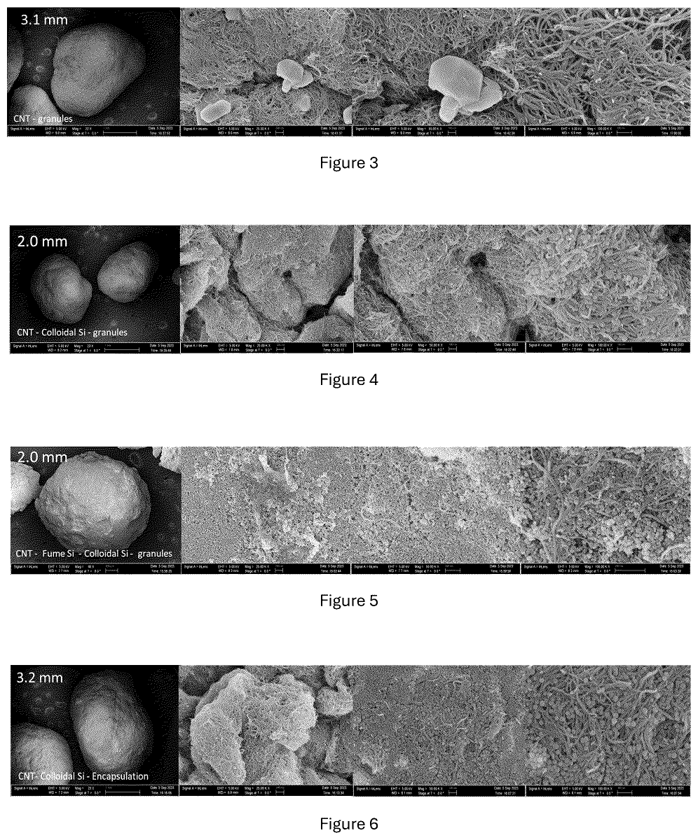

FIG. 3 displays SEM images of the CNT-nano-Al₂O₃ hybrid material granules, captured at magnifications of 22×, 25 K×, 50 K×, and 100 K×, from left to right respectively. The images reveal primary catalyst particles ranging from 700 to 1400 nm in size, supported on a mesh of MWCNTs with an approximate tube diameter of 10 nm.

### Example 2: Granulation of CNT-Nano-Al₂O₃ Hybrid Using a Colloidal Silica

CNT-nano-Al₂O₃ hybrid granules were prepared using an aqueous colloidal dispersion (LUDOX AS-40 available from Sigma-Aldrich) containing 40% synthetic amorphous silica with a nominal particle size of 22 nanometers as a binder. This solution was diluted with deionized water to a 5 wt. % solids content and added to the finely ground powder of the hybrid material, which contained 72% by weight of MWCNT. The resulting granules, approximately 2.0 mm in size, were air-dried at room temperature for 2 hrs. and at 60° C. for 30 minutes to remove excess moisture.

SEM images, captured at magnifications of 22×, 25 K×, 50 K×, and 100 K×, of the CNT-nano-Al₂O₃ hybrid material with colloidal silica, are shown in FIG. 4 (from left to right, respectively). The colloidal silica spheres are highly dispersed on the surface of the granules, binding the mesh of the hybrid carbon nanotube material. No catalyst particles are visible in the electron microscopy micrographs.

### Example 3: Granulation of CNT-Nano-Al₂O₃ Hybrid Using a Fume Silica

In another series of experiments, CNT-nano-Al₂O₃ granules were obtained through a two-step process. First, a fine powder of the hybrid material containing 72% MWCNT by weight was mixed with commercial fume silica powder in a 15/85 wt. % ratio. Then, a diluted colloidal silica solution (5 wt. % LUDOX AS 40) was added. After mixing the powders with the colloidal solution in a high shear mixer, granules of approximately 2 mm in size were formed. These granules were air-dried at room temperature and subsequently heated to 60° C. for 30 minutes to remove moisture.

SEM images, taken at magnifications of 22×, 25 K×, 50 K×, and 100 K×, of the mixed CNT-nano-Al₂O₃-fume silica-colloidal silica granules, are presented in FIG. 5 (from left to right respectively). Very few CNT-nano-Al₂O₃ hybrid material particles are observed, primarily because the high fume silica composition covers the surface of the granules. No catalyst particles are visible in the SEM images.

### Example 4: Encapsulation of CNT-Nano-Al₂O₃ Hybrid Material Granules with Colloidal Silica Particles

In this example, the granulation and encapsulation of CNT-nano-Al₂O₃ hybrid material was accomplished using colloidal silica. The granules of CNT-nano-Al₂O₃ hybrid material obtained in example 1 were coated with a colloidal silica solution containing 5 wt. % solid content and then air-dried at room temperature overnight.

SEM images of the encapsulated granules are displayed in FIG. 6 taken at magnifications of 22×, 25 K×, 50 K×, and 100 K×(from left to right respectively). A significant portion of the colloidal silica particles covers the surface of the granules, binding the CNT bundles. No alumina particles are visible in the electron microscopy micrographs.

### Example 5: Granulation of CNT-Nano-Al₂O₃ Hybrid Using Fly Ash and Colloidal Silica

In another series of experiments, CNT-nano-Al₂O₃ granules were obtained through a two-step process. First, a fine powder of the hybrid material containing 72% MWCNT by weight was mixed with fly ash powder in a 25/75 wt. % ratio. Then, a diluted colloidal silica solution (10 wt. % LUDOX AS 40) was added. After mixing the powders with the colloidal solution in a high shear mixer, granules of approximately 1 to 5 mm in size were formed. These granules were air-dried at room temperature and subsequently heated to 60° C. for 30 minutes to remove moisture.

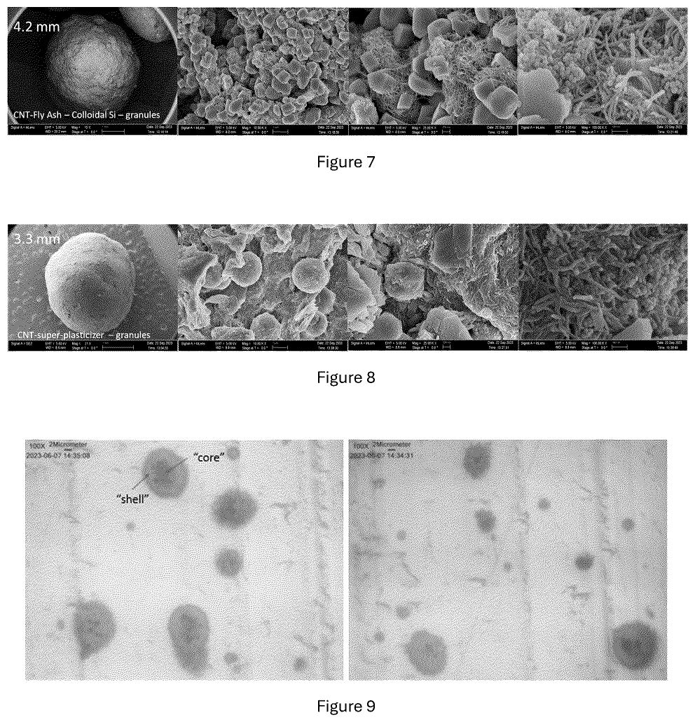

SEM images, taken at magnifications of 15×, 10 K×, 25 K× and 100 K×(from left to right, respectively), of the mixed CNT-nano-Al₂O₃-fly ash-colloidal silica granules, are presented in FIG. 7. It can be clearly observed that the carbon nanotube bundles are found separated and dispersed by the fly ash particles. In the image taken at 100 K× magnification, the colloidal silica particles are clearly visible, and they are found deposited in the spaces between the CNTs. The separation of the carbon nanotube bundles by the fly ash and colloidal silica particles facilitates their disaggregation and dispersion during their integration with cementitious materials.

### Example 6. Granulation of CNT-Nano-Al₂O₃ Hybrid Using Super-Plasticizer Agents

In this example, CNT-nano-Al₂O₃ granules were prepared by mixing the hybrid material with a commercial super-plasticizer agent in a specific proportion to achieve the required moisture content for producing 1 to 5 mm-sized granules using a high shear mixer equipment. These formed granules were subsequently dried under the conditions described in previous examples. There are many different companies producing superplasticizers. Some that have been used include products from Sika Corporation, specifically ViscoCrete®. Also, BASF produces the MasterGlenium® product line, GCP Applied Technologies offers ADVA®, Mapei Corporation provides Dynamon® and Polychem, and Euclid Chemical Company manufactures Eucon® and Plastol®, among others. The CNT/superplasticizer ratio can vary depending on the type. In some examples between 4 to 7 ml of Sika superplasticizer were used per gram of CNT.

SEM images, captured at magnifications of 21×, 10 K×, 25 K×, and 100 K×(from left to right respectively), of the CNT-nano-Al₂O₃ granules produced with a commercial super-plasticizer agent, are shown in FIG. 8. The images depict spherical granules of approximately 3.3 mm in diameter. Upon increasing magnification, the carbon nanotube bundles separated by the particles contained in the super-plasticizer agent become visible. These particles exhibit varying shapes and sizes. In the 100 K× image, carbon nanotubes and aggregates of small spheres, similar to those observed in colloidal silica, can be seen. These spheres are located within the gaps that separate individual nanotubes. The integration of carbon nanotubes into the cementitious material is facilitated by the separation of the bundles by the particles present in the super-plasticizer and its strong affinity for water upon contact.

Following includes a theory, based on the chemistry of cement particles and their relationship with improved mechanical strength, which can be helpful in explaining how CNTs improve the mechanical properties of cement, whether they are formed as bundles or a mesh.

The starting point is the ingredients in cement and their reactivity during the hydration process. Calcium silicates (C₃S and C₂S), comprising around 70 to 80 wt % of the composition, react with water to form colloidal particles, creating a hydrated gel and calcium hydroxide. Both compounds have lower density than calcium silicates, causing the paste volume to increase by approximately 117%. As the paste volume increases, porosity decreases, leading to improved mechanical properties and durability as the curing time increases.

Integrating carbon nanotubes with cement particles can reduce porosity of the cement because the nanoscale CNTs occupy some of the space between cement particles. When water is added to the cement and carbon nanotube mixture, and the particle size increases due to the hydration of calcium silicates, carbon nanotubes are redispersed in the paste. We have observed colloidal particles of silica can fill spaces between the bundles or mesh of carbon nanotubes (see FIGS. 15 and 16), creating a larger contact surface between nanotubes and hydrated gel, resulting in stronger interactions. Carbon nanotube-hydrated gel bridges the cementitious particles, further reducing the mixture's porosity. The particle size of the formed silicate gel, the dimensions and morphology of CNT bundles or mesh, and their composition in the paste are variables for enhancing the mechanical properties of the cement.

The simultaneous effects, such as reduced porosity, CNT-gel interaction strength, dispersion in the cement matrix, properties of gel particles, and morphological properties of CNTs, would help explain the improvement in mechanical properties.

### Example 7

This example describes the use of non-sonication, scalable methods to create CNT dispersions that enhance mortar mechanical performance. Composition: in water: 0.76 wt % hybrid CNT material with ˜66% CNT and ˜34% other cement-compatible composites, mainly alumina) including CNT 0.5 wt %; with alkali lignin (AL) as a dispersant at AL:CNT=2:1 ratio. “Air Minus” (AM) (an air-detraining admixture for cement/concrete, available from Fritz-Pak Corporation) was added as a defoamer at AM:CNT=1:1 ratio. Processing: shear mixing at 7,000 rpm for 3 hrs.

Zeta potential ˜57.3 mV (stable dispersion).

All mortar samples: water/cement/sand: 0.5/1.1/2.75, using standard graded sand per ASTM C-778.

Sample preparation: Mortars with water to cement ratio w/c=0.5 and sand to cement ratio s/c=2.75 were produced. An appropriate amount of the CNT dispersion sample was added such that total CNT % is 0.1 wt % of the cement. The mixing of the materials was performed according to procedure outlined by ASTM 305-20 using a standard robust mixer.

Specimens were cast in 20×20×80 mm3 oiled molds for the mechanical testing. All specimens remained molded for 24 h. Following demolding, the samples were stored in a curing room (20° C., 99.5% humidity) until testing.

Flexural Strength compared to plain mortar: 115% at day 3 and 117% at day 7.

Modulus of Elasticity compared to plain mortar: 110% at day 3 and 114% at day

7.

Compressive Strength compared to plain mortar: 105% at day 3 and 105% at day 7.

### Example 8

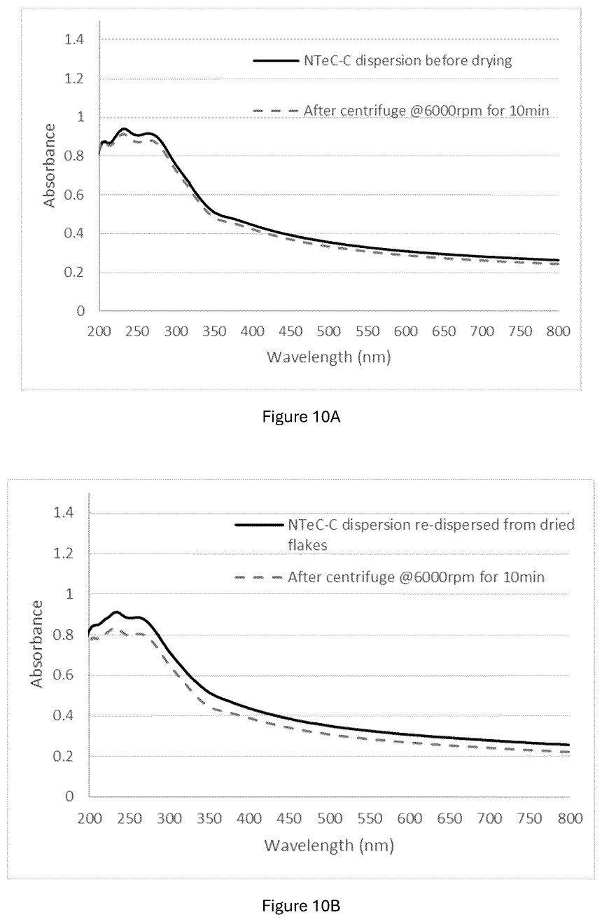

In this example scalable industrial methods such as spray drying are used to create dried granules from a liquid dispersion. The method creates generally spherical 3D granules (shown in FIG. 9). Composition: before drying: 0.76 wt % hybrid CNT material with ˜66% CNT and ˜34% other cement-compatible composites, mainly alumina) including CNT 0.5 wt %; using alkali lignin (AL) as dispersant at AL:CNT=2:1 ratio.

Processing: dispersion sample prepared by sonication, drying by spray drying using an air brush.

Shown in FIG. 9 are micrographs (at 100×) illustrating the morphologies of the granules. The cross-sections of the dried droplets resemble a “core-shell” structure, as perhaps best shown in the left micrograph. The creation of these structures is driven by differences in evaporation rate and surface energy, whereby the CNT-containing material is encapsulated by the lighter polymer-rich “shell.”

### Example 9

In this example, CNT-alumina hybrid material with ˜67% CNT (identified as “NTeC-C”™ in FIGS. 10A and 10B) was first dispersed in water using alkali lignin (AL) as a dispersant, at AL:CNT=2:1 wt. ratio. Sonication dosage between 400KJ/L and 800KJ/L was applied to disperse NTeC-C using tip sonicator with concurrent mechanical agitation from an overhead mixer. Dispersions with CNT concentration ranging from 0.6-1 wt % were obtained (optionally, non-dispersible particles/impurities can be removed by centrifugation at 5,000 rpm after sonication). An aliquot of dispersion was then oven-dried overnight at 50° C., and the dried dispersion was mechanically crushed into micro-encapsulated CNT-alumina hybrid material in the forms of flakes or granules. Finer powder can be obtained using grinding media, e.g. 3 mm zirconia beads, in a planetary mixer. The micro-encapsulated CNT-alumina hybrid material was then used for re-dispersion in water under different conditions.

The stability of dispersions against centrifugation (6,000 rpm, 10 min), measured by UV-vis spectroscopy where higher absorbance between 250-300 nm indicating well-dispersed CNTs, is shown in FIGS. 10A and 10B, where FIG. 10A is a plot of UV/Vis spectra of CNT-alumina hybrid material dispersion before drying and FIG. 10B shows it re-dispersed from dried flake. The close match between spectra is an indication of high quality and stable dispersion. FIGS. 10A and 10B indicate better dispersion. The close match between spectra before and after centrifugation is an indication of high quality and stable dispersion. Re-dispersion was done after mixing the dried flake with water and shear-mixing at 8000 rpm for 30 seconds followed by 30-second bath sonication.

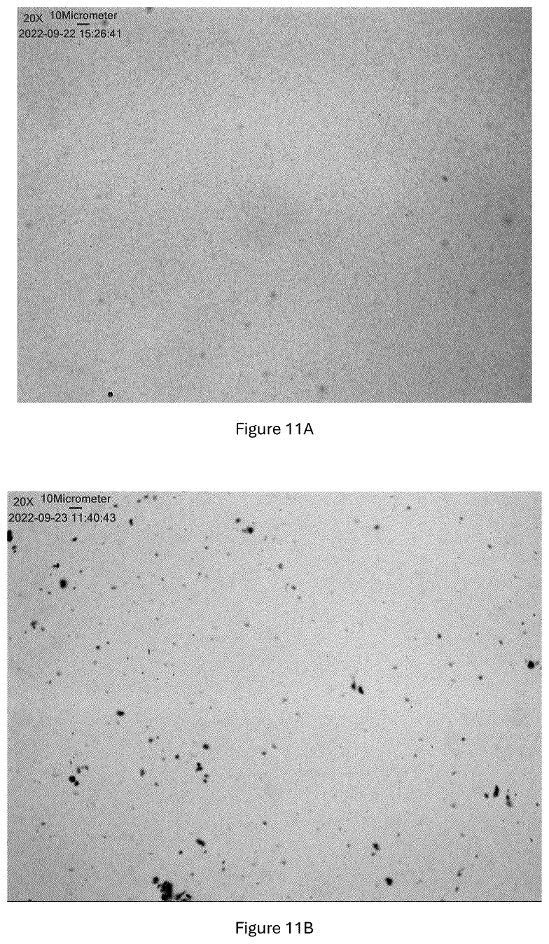

Optical microscopy (20×) of a dispersion before drying and after re-dispersion is shown in FIG. 11A (dispersion before drying) and FIG. 11B (after re-dispersion). In FIG. 11A, the absence of dark particles indicates no CNT agglomerates at this scale. While FIG. 11B shows more dark particles suggesting the presence of some non-dispersed CNTs after re-dispersion, the overall dispersion quality of both samples is relatively comparable. Re-dispersion was done after mixing the dried flakes with water and shear-mixing at 8,000 rpm for 30 seconds followed by 30-second bath sonication. Re-dispersion conditions: Gentle shake-finer particles re-dispersed spontaneously, but not sufficient to disperse larger flakes. Shear mixing at 8,000 rpm for 30 sec-only a few larger flakes remain visible.

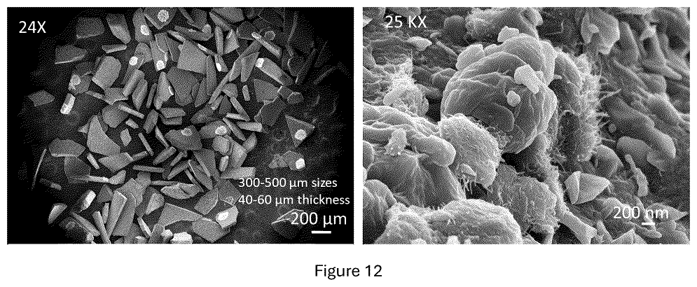

FIG. 12 includes two SEMs of the micro-encapsulated CNT-alumina hybrid material flakes of this Example 9, at 24× (left image) and 25 K×(right image). These images illustrate flakes ranging in size from about 300 to about 500 microns and with a thickness of about 40 to about 60 microns. The nanotubes are embedded within the polymeric matrix, as clearly visible in the high-resolution image.

A number of implementations have been described. Nevertheless, it will be understood that additional modifications may be made without departing from the scope of the inventive concepts described herein, and, accordingly, other examples are within the scope of the following claims.

1. An agglomeration, comprising:
fine particles of a hybrid material comprising carbon nanotubes (CNT); and
a binder agent that is effective to create an agglomeration comprising the fine particles.

2. The agglomeration of claim 1, further comprising cementitious material.

3. The agglomeration of claim 2, wherein the cementitious material comprises alumina particles.

4. The agglomeration of claim 2, wherein the cementitious material comprises nano-alumina particles.

5. The agglomeration of claim 2, further comprising an admixture of one or more other cementitious materials.

6. The agglomeration of claim 5, wherein the one or more other cementitious materials comprises one or more of fume silica, fly ash, limestone, and a hydrogel.

7. The agglomeration of claim 2, wherein the cementitious material comprises one or more of fume silica, fly ash, or limestone.

8. The agglomeration of claim 7, wherein the binder agent comprises one or more of colloidal silica or colloidal alumina.

9. The agglomeration of claim 1, wherein the binder agent comprises colloidal material.

10. The agglomeration of claim 9, wherein the colloidal material comprises one or more of colloidal silica or colloidal alumina.

11. The agglomeration of claim 1, wherein the binder agent comprises a superplasticizer.

12. The agglomeration of claim 1, wherein the fine particles are created by grinding CNT hybrid material.

13. A method of dispersing carbon nanotubes (CNT) in cementitious material comprising:
creating the agglomeration of claim 1; and
blending the agglomeration with one or more components of cement, to develop an intermediate product.

14. The method of claim 13, further comprising creating concrete using the intermediate product.

15. Concrete created by the method of claim 14.

16. An encapsulated carbon nanotube (CNT)-containing hybrid material structure, comprising:
a core; and
a shell surrounding some or all of the core and comprising a polymer or a macromolecule;
wherein the concentration of the hybrid material is greater in the core than it is in the shell.

17. The encapsulated CNT-containing hybrid material structure of claim 16, wherein the hybrid material comprises CNT and a cementitious material.

18. The encapsulated CNT-containing hybrid material structure of claim 17, wherein the cementitious material comprises alumina.

19. The encapsulated CNT-containing hybrid material structure of claim 16, wherein the polymer comprises alkali lignin.

20. The encapsulated CNT-containing hybrid material structure of claim 16, wherein the macromolecule comprises at least one of a superplasticizer, a defoaming agent, and a binder.

21. The encapsulated CNT-containing hybrid material structure of claim 16, made by spray drying a liquid dispersion of a CNT-containing hybrid material and a dispersant.

22. A mortar comprising the encapsulated CNT-containing hybrid material structure of claim 15, water, cement, and sand.

23. A concrete comprising the encapsulated CNT-containing hybrid material structure of claim 15, water, cement, sand, and gravel.
